(19) United States
(12) Patent Application Publication
(10) Pub. No.: US 2014/0262284 A1
(43) Pub. Date: Sep. 18, 2014

(54) METHOD OF FORMING AND COMPRESSING CARBON DIOXIDE

(71) Applicant: Enerjetik LLC, Commerce City, CO (US)

(72) Inventors: JAMES E KLEPPER, Thornton, CO (US); Kenneth L. Klepper, Arvada, CO (US); Ron Stites, Brighton, CO (US)

(73) Assignee: Enerjetik LLC, Commerce City, CO (US)

(21) Appl. No.: 14/200,773

(22) Filed: Mar. 7, 2014

Related U.S. Application Data
(60) Provisional application No. 61/790,732, filed on Mar. 15, 2013.

(51) Int. Cl. C01B 31/20; E21B 43/16; F02M 21/02

(52) U.S. Cl. CPC C01B 31/20; F02M 21/0203; E21B 43/164
USPC 166/305.1; 423/437.1; 60/780

(57) ABSTRACT

A method and apparatus to form and compress relatively pure carbon dioxide includes a syngas generator which forms syngas and directs it into a combustion chamber where it is combined with oxygen and combusted to form relatively pure carbon dioxide. A first portion of the formed carbon dioxide is directed to a compressor which is powered by an internal combustion engine. A second portion of the formed carbon dioxide is combined with oxygen and used in combination with a carbonaceous fuel to power the internal combustion engine. This produces exhaust gas which is relatively high purity carbon dioxide which is combined with the carbon dioxide formed by combusting the syngas.

### BACKGROUND OF THE INVENTION

In order to increase production of oil and gas from wells, gas is often pumped into the well. This pumped gas then forces the natural gas or oil from the well, increasing recovery. Certain gases are preferred, particularly ones that dissolve in the natural gas or oil. Low nitrogen content is important, and relatively pure carbon dioxide is one preferred gas.

Carbon dioxide can be formed in a variety of different manners. If formed from combustion products using air, the carbon dioxide must be purified. The purification must be done in a factory, and the carbon dioxide, in turn, shipped to the site for use. This is relatively expensive and inefficient. Even when, for example, methane is combusted with oxygen, unwanted by products can be formed.

One method of forming relatively pure carbon dioxide is disclosed in U.S. application Ser. No. 13/681,593, filed Nov. 20, 2012, entitled Method Of Making Carbon Dioxide, the disclosure of which is hereby incorporated by reference. Once formed, the carbon dioxide must be pumped into the well. This generally requires a compressor which is generally powered by a combustion engine. As such, this combustion engine burns a fuel and produces carbon dioxide.

### SUMMARY OF THE INVENTION

The present invention is premised on the realization that by combining a syngas reactor to produce carbon dioxide with an internal combustion engine, the bi-products of the internal combustion engine can be combined with the carbon dioxide produced by the syngas reactor to increase carbon dioxide production.

More particularly, the present invention utilizes a syngas reactor to produce high purity carbon dioxide. A first portion of this high purity carbon dioxide is combined with oxygen and fuel and used to power an internal combustion engine. The produced exhaust from the internal combustion engine will thereby be relatively high purity carbon dioxide with little or no nitrogen. The exhaust gas can then be combined with the carbon dioxide from the syngas reactor. A second portion of the carbon dioxide from the syngas reactor is then compressed, and can be injected into a well or a pipeline or storage facility. The compressor is powered by the internal combustion engine. This system reduces costs, increases production, and reduces air pollution.

The objects and advantages of the present invention will be further appreciated in light of the following detailed description and drawings in which:

### BRIEF DESCRIPTION OF THE DRAWING

FIG. 1 is a diagrammatic cross sectional view of an apparatus for use in producing carbon dioxide from syngas; and

FIG. 2 is a diagrammatic depiction of an apparatus used to compress and inject carbon dioxide into a well head.

### DETAILED DESCRIPTION

Syngas is a combustible gas which is formed by combusting a carbon source with a sub-stoichiometric amount of oxygen in the presence of steam to produce, in turn, a combination of carbon monoxide and hydrogen, both of which are combustible. It can be produced by a variety of different apparatus, in particular, the apparatus, disclosed in U.S. Pat. No. 6,863,878, as well as that disclosed in PCT application WO 2010/127062 A1, the disclosures of which are hereby incorporated by reference.

As shown in FIG. 1, a syngas reactor 10, which is similar to the reactor disclosed in WO2010/127062 A1, includes a feed inlet 12 which leads to a horizontal reactor 14 having a combustion nozzle 16. Nozzle 16 is adapted to heat carbon feed introduced into the horizontal reactor 14. Horizontal reactor 14, in turn, leads to a cylindrical residence chamber 18 which has a gas outlet 20.

The horizontal reactor 14 as shown includes a steel casing and a refractory liner which defines a tubular horizontal reaction area 23. The carbonaceous feed passes through inlet 12 into reaction area 23 immediately downstream from a combustion zone 26 immediately forward of combustion nozzle 16. The width and length of reaction are determined by feed rate and the capacity to generate the requisite heat.

A second end 60 of the horizontal reaction area 23 leads into the resonance chamber 18. As shown, the reaction area 23 is aligned along a tangent with the cylindrical resonance chamber 18. The resonance chamber 18 has a cylindrical wall and a closed top 64. The wall has a steel casing and a refractory lining. A gas outlet 20 extends through the top 64 into the resonance chamber 18 slightly below the inlet 60 from the horizontal reaction area 23. Also extending through the closed top 64 is a test port inlet 66.

The resonance chamber 18, in turn, has a bottom end which is in communication with a frustoconical section 70. Again, this section 70 has a steel casing and a refractory lining. Section 70 has a tapered side wall and a narrowed bottom outlet which is in communication with a recovery tank partially filled with water (not shown).

Gas outlet 20 extends to a nozzle 75 having an oxygen inlet 69. The combustion chamber 71, in turn, has an exhaust outlet 72. Coils 73 extend into the combustion chamber 71.

Exhaust outlet 72 leads to a reverse particulate separator 80. Separator 80 includes a carbon dioxide outlet line 82 leading to an air cooler 84 designed to reduce the temperature of the carbon dioxide. Line 86 directs the carbon dioxide from the cooler 84 to a further separator 88 designed to separate water from the carbon dioxide. The output line 90 from separator 88 in turn leads to a screw compressor 92 which can either be powered by an engine or an electric motor. The compressor 92 has an outlet line 94 which directs the carbon dioxide from the compressor through a series of oil separators 96 and 98. Separator 96 includes a carbon dioxide outlet line 100 which leads to a storage tank 102.

From the storage tank, the carbon dioxide is directed either through line 122 or line 104. Line 104 directs the carbon dioxide through water scrubber 106 to a compressor unit 108, and specifically to the initial stage 110 of the compressor unit 108. This will initially compress the carbon dioxide and direct it through line 112 to an air cooler 114. From the air cooler, line 116 goes through a second scrubber 118 to a second stage 120 of the compressor 108 which forces the compressed gas to an injection well through line 121.

Carbon dioxide which passes through line 122 flows through a metering valve 124 to line 126. Likewise, oxygen formed from a pressure swing absorbers (PSA) 127 goes through line 128, through a metering valve 130, to line 126. Line 126 leads to a carburetor 132 of an internal combustion engine 136. A second line 134 directs fuel into the carburetor 132. The exhaust system 138 of the internal combustion engine 136, is connected by line 140 to the combustion chamber 71 (see FIG. 1).

The feed material for the reactor 10 can be any carbonaceous material. It can be formed from organic material, polymeric material such as ground tire, wood, coal, and the like. The carbon source can be natural gas, methane or propane as well. Preferably, the feed will be a devolatilized carbon source in which reactive oxygen has been eliminated, as well as other organic components using a devolatilization reactor, such as that disclosed in U.S. Pat. No. 6,863,878, the disclosure of which is hereby incorporated by reference. This is upstream of apparatus 10 and not shown in the drawings.

Syngas or other fuel such as propane or natural gas, is introduced through the nozzle 16 and, at the same time, oxygen from PSA 127 is added so that stoichiometric combustion occurs at the combustion chamber. The oxygen is relatively pure, preferably at least 90% pure, preferably 95% pure and generally 98% pure or better. Nitrogen content should be minimized, generally 3% or less. The oxygen is produced by the pressure swing absorber unit 127, which is pressurized by air screw compressor 144, powered by engine 136. Likewise, steam is added.

This combustion at nozzle 16 will generate the heat necessary to cause the substoichiometric reaction of the carbon with steam and any additional oxygen as necessary to form syngas. The burner temperature should be at least 1300° F., more typically 2300° F.

In operation, feed material introduced into apparatus 10 will pass through inlet 12 and pass into the reaction area 23 immediately downstream from the combustion nozzle 16. The intersection of the vertical and horizontal feed conveyor provides a seal, preventing gas from flowing out the feed inlet.

Combustion nozzle 16 has multiple concentric passages. As the oxygen and fuel are introduced into the burner nozzle 16, a blend of oxygen and water or steam is introduced also at nozzle 16, but slightly downstream of the initial combustion area. The heat from the combustion raises the temperature of the water/steam enabling it to react with carbon in the reaction area 23. The added oxygen increases the temperature of the gas stream during the reducing reaction immediately downstream of the stoichiometric combustion in the combustion chamber. The added oxygen also promotes formation of carbon monoxide. Generally, the additional oxygen will be very minor, less than 1% of the water by weight. The steam swirls around, combines with the combustion products from the stoichiometric combustion and contacts the carbon source introduced through inlet 12.

It is desirable to have the temperature in the horizontal reaction chamber 23 to be at least about 1200° F., and generally 2300° F., or more. At 2300° F., any ash that remains from the char will be melted.

The pressure in the reaction zone can be from atmospheric up to 1000 psig. Pressure is not a determining factor in the reaction, but is incidental to reaction conditions.

The combustion at nozzle 16 creates a high velocity gas stream that will pass through the reaction chamber into the resonance chamber 18. Chamber 18, also maintained at at least 1000° F., provides sufficient time for complete reaction. Generally, the gas will be in the reaction area 23 from about 0.1 to 0.3 seconds, with the velocity of the gas passing through the chamber about 500 to about 3000 ft/sec.

The horizontal reaction area 23 is linear and its second end 60 is aligned tangentially with the cylindrical wall 62 of the residence chamber 18 causing a swirling movement of the gas around the wall 62 of the residence chamber 18. As the reaction continues, gas is forced downwardly, and the syngas will be collected from outlet tube 20.

The syngas from outlet tube 20 passes through nozzle 75 and is combined with additional relatively pure oxygen from PSA 127 through line 146, and ignited. The amount of oxygen must be controlled so that excess oxygen is not present. By monitoring the combustion output gases, one can determine if excess oxygen is present. Generally, there should be less than about 2%, preferably less than 1%, and more particularly less than 0.5% of oxygen measured as argon/oxygen in the combustion product. If excess oxygen is present, additional unreacted side products will form and relatively pure carbon dioxide will not be obtained. This combustion will create heat and primarily carbon dioxide and water.

The formed carbon dioxide passes through line 72 to a reverse particulate separator 80. Water is introduced into line 72 prior to separator 80. As shown, water is collected through line 148 and the carbon dioxide, which should be about 220° F., is emitted through line 82 to air cooler 84, which is intended to reduce the temperature to 130° F., or less. From the cooler 84, the carbon dioxide passes through line 86 to separator 88 which collects any additional water through line 150 and emits the carbon dioxide through line 90, which then passes to a screw compressor 92 which can be powered by engine 136 or by a separate electric motor or engine. Compressor 92 compresses the carbon dioxide and directs it through line 94 to a series of oil separators 96 and 98, and the carbon dioxide then passes through line 100 to storage tank or surge vessel 102.

At this point, the temperature should be about 180° F., at a pressure of around 150 psig, although obviously this can be modified based on design parameters. Surge vessel 102 includes a water outlet 152. From the surge vessel, the carbon dioxide can be directed either through line 104 or line 122. Carbon dioxide going through line 122 is controlled by a metering valve 124. In addition, oxygen formed from the PSA 127 passes through line 128 and is regulated by valve 130. Valves 130 and 124 are designed to establish a desired ratio of carbon dioxide to oxygen for proper combustion in engine 136. Generally, a 75:25 mixture by volume of carbon dioxide to oxygen is preferred.

This gas mixture is then introduced into the carburetor 132. Fuel is also introduced through line 134 into the carburetor 132. The fuel can be natural gas, propane, syngas, or other fuels. The fuel, carbon dioxide and oxygen is combined in engine 136 and combusted, powering the engine. The exhaust emitted through exhaust system 138 is directed through line 140 and combined with carbon dioxide product by combustion of syngas. The engine 136, itself, has a drive shaft 154 which operates the compressor 108 as well as compressor 144 which powers the PSA 126.

The carbon dioxide in line 104, generally about 150 psig and 130° F., passes through water scrubber 106 and is introduced into the first stage 110 of the injection compressor 108. This first stage of the compressor directs the compressed carbon dioxide through line 112 to an air cooler 114, then through line 116 to the second stage 120 of compressor 108. The second stage 120 will then increase the pressure of the carbon dioxide to the desired pressure (100-2100 psig), which can be, for example, 2000 psig at 290° F., for injection into the well (not shown).

Thus, the present invention provides a basically closed system for production of carbon dioxide and injection of the carbon dioxide into a well. The system provides for production of relatively high purity carbon dioxide. Because this is high purity carbon dioxide with minimal nitrogen content, it can be combined with oxygen to dilute the oxygen to a desired concentration to oxidize combustion fuel in the internal combustion engine. Because of this, the exhaust from the internal combustion engine will have no more nitrogen than the combustion gases. The exhaust gas can be reintroduced into the system and, in turn, injected into the well. This reduces costs and carbon dioxide emission while producing a relatively pure carbon dioxide.

This has been a description of the present invention. However, the invention should only be defined by the appended claims,

Wherein we claim:

1. A method of forming and compressing carbon dioxide comprising:
forming carbon dioxide by combining syngas with oxygen to form a combustible gas;
combusting said combustible gas with oxygen in a combustion chamber to form produced carbon dioxide;
combining a first portion of said carbon dioxide with oxygen and fuel to form a combustion mixture; and
fueling an internal combustion engine with said combustion mixture thereby forming an exhaust gas;
powering a compressor with said internal combustion engine; and
directing a second portion of said carbon dioxide to said compressor which thereby compresses said gas; and
directing said exhaust gas from said internal combustion engine and blending said exhaust gas with said produced carbon dioxide.

2. The method claimed in claim 1 wherein said syngas is formed by establishing a flowing stream of hot gas by combusting a fuel at an inlet nozzle to form first combustion products;
combining said first combustion products at said combustion nozzle with steam to establish said stream of hot gas; and
adding a carbon source to said stream of hot gas at a temperature effective to form syngas.

3. The method claimed in claim 2 wherein said syngas is combined with oxygen and combusted in a combustion chamber and wherein said exhaust gas is introduced into said combustion chamber.

4. The method claimed in claim 3 wherein said internal combustion engine powers a pressure swing absorber.

5. The method claimed in claim 4 wherein said compressor compresses said carbon dioxide to a pressure of 100-2100 psig and injects said carbon dioxide into a well.

6. An apparatus to form and compress carbon dioxide comprising:
an internal combustion engine;
a carbon dioxide generator comprising a syngas source and a syngas combustor and a carbon dioxide outlet;
said carbon dioxide outlet having a first line directed to said internal combustion engine and a second line directed to a first compressor powered by said internal combustion engine;
said compression effective to compress said carbon dioxide; and
said internal combustion engine having an exhaust line said exhaust line leading to said carbon dioxide generator.

7. The apparatus claimed in claim 6 further comprising a second compressor powered by said internal combustion engine said second compressor operable to power a pressure swing absorber; and
said pressure swing absorber effective to produce oxygen and further including an oxygen line from said PSA to said internal combustion engine.

8. The apparatus claimed in claim 6 further comprising an oxygen line from said PSA to said syngas combustor.
